(19) United States
(12) Patent Application Publication
(10) Pub. No.: US 2014/0167898 A1
(43) Pub. Date: Jun. 19, 2014

(54) SYSTEMS AND METHODS FOR COUPLED POWER INDUCTORS

(71) Applicant: The Trustees of Columbia University in the City of New York, New York, NY (US)

(72) Inventors: Noah Andrew STURCKEN, New York, NY (US); Cheng CHENG, New York, NY (US); Ryan DAVIES, New York, NY (US); William BAILEY, New York, NY (US)

(73) Assignee: The Trustees of Columbia University in the City of New York, New York, NY (US)

(21) Appl. No.: 14/094,080

(22) Filed: Dec. 2, 2013

Related U.S. Application Data
(63) Continuation of application No. PCT/US2012/040147, filed on May 31, 2012.
(60) Provisional application No. 61/491,753, filed on May 31, 2011.

(51) Int. Cl. H01F 27/245

(52) U.S. Cl. CPC H01F 27/245
USPC 336/170; 336/212

(57) ABSTRACT

Power inductor has a magnetically isotropic core including two or more laminations. At least a first lamination can include anisotropic magnetic material having a first orientation of magnetic anisotropy. At least a second lamination can include anisotropic magnetic material having a second orientation of magnetic anisotropy, the second orientation being different than the first orientation.

### CROSS-REFERENCE TO RELATED APPLICATIONS

This application is a continuation application of International Application No. PCT/US2012/040147, filed on May 31, 2012, which claims priority to U.S. Provisional Patent Application Ser. No. 61/491,753, filed on May 31, 2011, each of which is incorporated by reference herein in its entirety.

### STATEMENT REGARDING FEDERALLY-SPONSORED RESEARCH

This invention was made with government support from the U.S. Department of Energy under Grant No. DE-EE0002892 and the National Science Foundation under Grant No. EECS-0903466. The government has certain rights in the invention.

### BACKGROUND

The disclosed subject matter relates to systems and methods for coupled power inductors, including inductors having a crossed anisotropy magnetic core.

Desirable properties for a magnetic core in an inductor can include high permeability and low coercivity. Coercivity is a measure of the hysteresis in the magnetic material, and this can be an undesirable property in a magnetic material for inductor applications, because coercivity can result in wasted energy. Improved magnetic behavior can be found in certain soft magnetic materials such as Co-4% Zr-4.5% Ta or Ni-20% Fe along the so-called hard axis, with respect to the induced anisotropy. A different axis, the easy axis, can have a relatively large coercivity and thus is not suitable for certain inductor core applications.

Inductance can be proportional to the permeability along the path of the magnetic flux in the device. Any point of low permeability along the path of the magnetic flux can dominate, and can substantially reduce the inductance value. The path of magnetic flux must form a closed loop, and so as the flux curls around the loop its orientation can at some point occupy all directions within the plane of the loop. This can be at odds with the anisotropic behavior of certain soft magnetic materials, in that they only have high permeability along the hard axis direction.

There is an opportunity for improved inductors that solve these problems.

### SUMMARY

Systems and methods for coupled power inductors are provided herein.

In one embodiment of the disclosed subject matter, a magnetically isotropic core includes two or more laminations. At least a first lamination can include anisotropic magnetic material having a first orientation of magnetic anisotropy. At least a second lamination can include anisotropic magnetic material having a second orientation of magnetic anisotropy, the second orientation being different than the first orientation.

In some embodiments, the core can include at least three laminations, and at least a third lamination can include anisotropic magnetic material having a third orientation of magnetic anisotropy, the third orientation being different than each of the first or second orientations.

In some embodiments, the core can include successive laminations of anisotropic magnetic material, and each lamination in the successive laminations can have a rotated magnetic orientation of anisotropy relative to the orientation of a preceding lamination in the successive laminations.

In some embodiments, the anisotropic magnetic material can be an amorphous alloy of Cobalt, Tantalum, and Zirconium, or a polycrystalline or crystalline alloy of Nickel and Iron. The core can further include an insulating layer between each two successive laminations of the anisotropic magnetic material, and the insulating layer can include a layer of SiO2. The insulating layer can further include a layer of Ta. The insulating layer can be within a range between about 5-10 nanometers thick.

According to another aspect of the disclosed subject matter, an inductor can include a core having any of the features described herein. In some embodiments, the core can have a toroidal configuration. The core can have a ladder topology including at least two rungs and a spacing therebetween, and the winding can include separate sets of windings each wrapping around one of at least two rungs, respectively. The core can include four rungs and four sets of windings each wrapping around one of the four rungs, respectively.

According to another aspect of the disclosed subject matter, a microchip or integrated circuit can include an inductor having any of the features described herein. In some embodiments, the microchip can be used for a DC-DC power converter.

### BRIEF DESCRIPTION OF THE DRAWINGS

FIG. 1 is a diagram illustrating an exemplary power inductor according to the disclosed subject matter.

FIG. 2 is an image illustrating certain aspects of the power inductor of FIG. 1.

FIGS. 3A-3B are images illustrating certain aspects of the power inductor of FIG. 1.

FIG. 4 is a diagram illustrating certain aspects of the power inductor of FIG. 1.

FIG. 5 is a cross-sectional diagram of the power inductor of FIG. 1.

FIG. 6 is a cross-sectional diagram of an exemplary integrated circuit including a power inductor of FIG. 1.

FIG. 7 is a cross-sectional diagram of another exemplary integrated circuit including a power inductor of FIG. 1.

FIG. 8 is a diagram illustrating certain aspects of the power inductor of FIG. 1.

FIG. 9 is a schematic diagram illustrating certain aspects of the power inductor of FIG. 1.

FIG. 10 is a diagram illustrating certain aspects of the power inductor of FIG. 1.

FIG. 11 is a diagram illustrating certain aspects of the power inductor of FIG. 1.

Throughout the drawings, the same reference numerals and characters, unless otherwise stated, are used to denote like features, elements, components or portions of the illustrated embodiments. Moreover, while the disclosed subject matter will now be described in detail with reference to the Figs., it is done so in connection with the illustrative embodiments.

### DETAILED DESCRIPTION

One aspect of the disclosed subject matter relates to systems and methods for coupled power inductors, which can include, for example, a magnetically isotropic core. The disclosed subject matter can be used, for example, for coupled toroidal inductors with a magnetic core including laminations with successively rotated orientation of anisotropy to provide an effectively isotropic core. Additionally, the disclosed subject matter can be used for a variety of applications, for example and without limitation, an integrated circuit and/or a DC-DC power converter including a coupled power inductor as described herein.

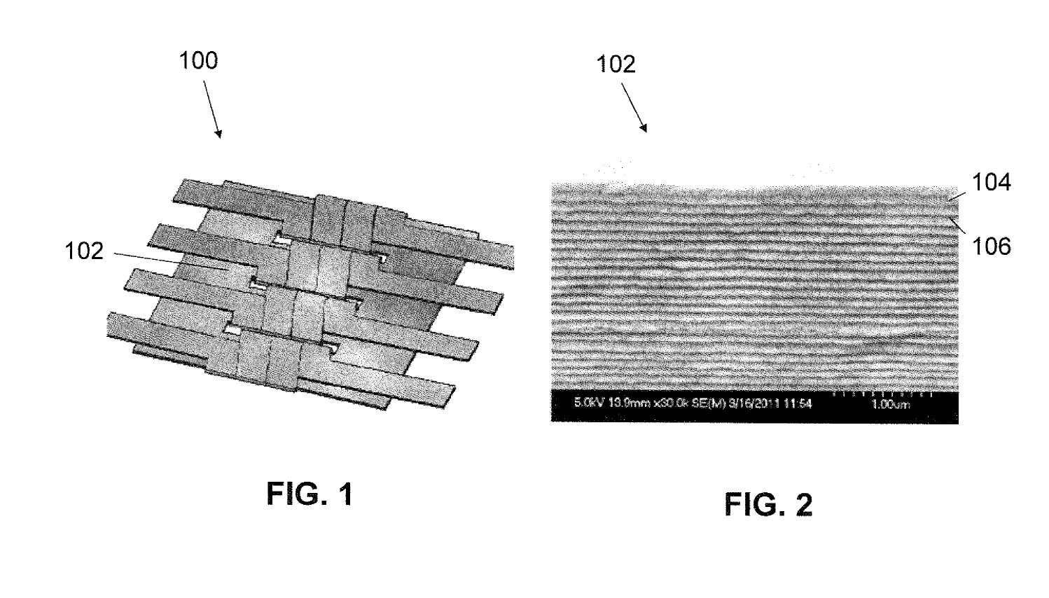

FIG. 1 is a schematic diagram of a power inductor 100 according to one aspect of the disclosed subject matter. As embodied herein, the power inductor 100 can have a geometry similar to a ladder, where each of the rungs is a solenoid inductor that is coupled through the stringers of the ladder. A core 102 of the power inductor can include two or more laminations 104 of anisotropic magnetic material, such as Co_{91.5}Zr_{4.0}Ta_{4.5} (CZT) or other suitable materials or ratios of materials as described below, and an orientation of anisotropy can be rotated between successive pairs of laminations 104 to produce an effectively isotropic core.

Exemplary laminations 104 are shown in FIG. 2. As embodied herein, an insulating bi-layer 106 of SiO₂, or other suitable metal-oxide, and Ta separates magnetic laminations 104. The SiO₂ of layer 106 can suppress eddy currents while the Ta of layer 106 helps to smooth roughness in the sputtered SiO₂ layer. Coupling between inductors can be employed to avoid magnetic saturation and improve converter transient response. Further, the core 102 of power inductor 100 can be generally planar, and a thickness of the lamination 104 thickness and a spacing between layers can be selected, as discussed further below, to avoid formation of domain walls as well as eddy currents, which can increase losses at high frequency.

The core 102 can be generally planar, and thus can allow for reduced losses. For example, the planarity of the core can be similar to the thickness of the insulating lamination, which can be about 5-10 nm thick. Laminating the core 102 with insulating layers can suppress losses due, for example, to eddy currents, yet the coercivity, or hysteresis, of the magnetic material can be a source of loss in the inductor. Coercivity can be a result of two magnetic processes: single-domain rotation and domain wall motion. The coercivity associated with single-domain rotation can be reduced by material selection and improvement of deposition conditions. Losses from domain wall motion can be reduced by selecting a thickness of the spacer layer between adjacent laminations of magnetic material that have the same orientation of anisotropy to promote flux closure, or dipolar-coupling, between the adjacent layers, which can suppress domain formation.

As embodied herein, Co_{91.5}Zr_{4.0}Ta_{4.5} (CZT), or another suitable material having relatively high saturation magnetization, low coercivity and relatively high resistivity, can be chosen as the insulating material. An exemplary insulating material can have a saturation magnetization of about 1 T or greater, and in some embodiments within a range of about 1-2 T, can have a resistivity within a range of about 1-100 μΩ-cm, and can have a coercivity less than about 1 Oe. CZT, for example, can have an increased induced anisotropy field (Hk) compared to other compositional variants of Ni—Fe, which can overcome shape anisotropy in a core 102 according to the disclosed subject matter.

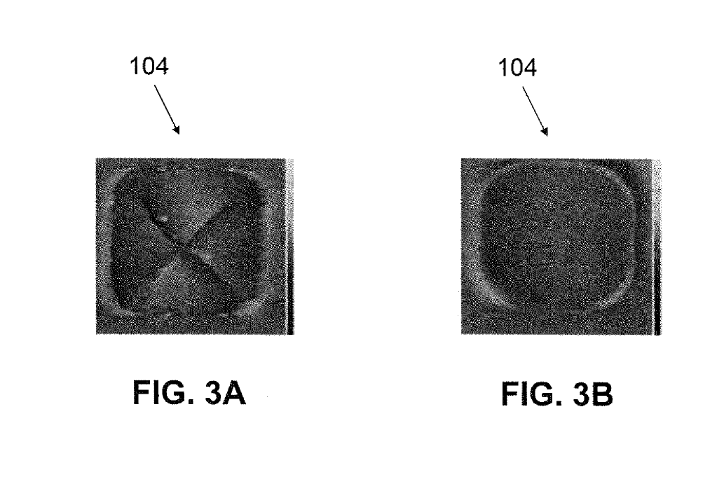

Dipolar-coupling between adjacent layers 104 can reduce or even eliminate the presence of domain walls within the core, and thus can reduce losses associated with domain-wall motion. FIGS. 3A-3B are magnetic force microscopy (MFM) images of an exemplary single-layer (FIG. 3A) and an exemplary dipolar-coupled bi-layer (FIG. 3B) of magnetic material patterned as a tile. Domain walls are shown in the single layer in FIG. 3A and are absent in the bi-layer in FIG. 3B. To reduce or avoid formation of domain walls, the spacing between magnetic laminations 104 should be about 10 nm to close the path of magnetic flux, which can be induced by easy axis magnetization, and can be closed between adjacent layers while avoiding the formation of pin-holes in the insulating spacer layer 106 that can allow the laminations 104 to be exchange-coupled. Likewise, the thickness of the spacer layer 106 can be thick enough to outweigh convexity that can occur in the films and result in orange-peel coupling between layers. Exchange or orange-peel coupling between adjacent magnetic layers 104 can allow the formation of domain walls within the core 102.

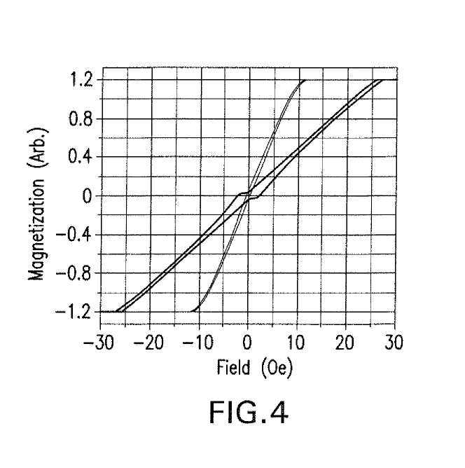

FIG. 4 shows the easy-axis and hard-axis magnetization curves of a CZT bi-layer, embodied as a 400 m-by-100 m bar. The shape of the easy axis curve around magnetic field strength of 0 Oe as shown can be due to the resistance of bi-layer to nucleation of additional domains within each layer when the two layers are dipolar-coupled. Compared to a conventional core having a non-planar topography, core losses due to hysteresis from orange-peel coupling can be improved.

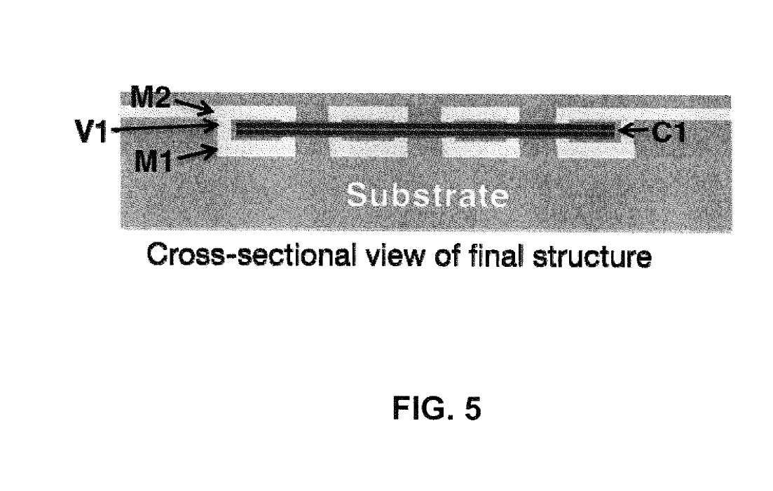

According to another aspect of the disclosed subject matter, FIG. 5 shows a cross-sectional diagram of a power inductor 100. Fabrication of a power inductor 100 according to the disclosed subject matter can include sequential deposition of bottom copper windings, a magnetic core, copper vias and top copper windings, with one or more depositions of thin films for insulating, adhesion or seeding interspersed. Deposition techniques for fabricating power inductor 100 include electrodeposition, high-vacuum sputtering, and spinning (which can be used, for example, for deposition of polymers). As embodied herein, the copper layers (bottom (M1), vias (V1) and top (M2)) can be deposited by electrodeposition, with a sputtered seed layer. The magnetic core (C1) can deposited by high vacuum (HV) sputtering, and several of the insulating layers can be composed of a commercial polymer, SU-8, that can be spun-on.

Copper, or another suitable material having relatively low resistivity can be chosen for an interconnect, which can be patterned with a damascene process. In the damascene process, the copper can be electroplated onto a copper seed layer, which can be deposited on a permanent insulating polymer layer and patterned with trenches. The copper can be plated to a thickness overfilling the trenches. The resulting substrate can undergo chemical mechanical polishing to planarize the surface by removing copper down to about the top of the insulating layer, leaving a planar surface with copper filling the trenches in the insulator. The substrate surface can be planar to within a few nanometers following deposition of the first metal layer, which can help avoid orange-peel coupling in the magnetic layers. To further reduce the resistive losses in the inductor, a relatively large cross-sectional area for the copper windings can be utilized, for example within a range between about 100 μm² to 1000 μm², however, the lithography process can constrain the copper thickness to around 5 μm, and thus the resolution can allow a space of about 5 μm that can be reliably patterned in the copper film.

The lamination of the core material can preclude the use of some processing techniques for patterning thin films. Thus, the lithography techniques for patterning the magnetic core can include ion milling, lift-off, and the like. In an inductor 100 according to the disclosed subject matter, magnetic flux can travel in the same plane as the core, and a relatively large cross sectional area for the magnetic core can be utilized to reduce reluctance of the magnetic flux to travel in this manner. Nevertheless, ion milling can be impractical for patterning relatively thick (several μm) metal films, where a mask of similar thickness as the core itself can be desired.

Lamination of the core material can include a bi-layer photoresist lift-off process, in which a relatively thick layer of a polymer, for example LOR 30B or the like, can be spun onto the substrate and soft-baked, and a thin layer of photoresist material, such as Microposit S1811, photoresist can be spun on and soft baked. For example, the polymer can have a thickness within a range between about 5-6 μm. The resulting photosensitive polymer bi-layer can be patterned, for example, using optical contact lithography with a desired core geometry. The photoresist mask can be developed, and the underlying LOR 30B can dissolve faster than the S1811 photoresist, and thus can form an undercut in the resist mask to allow lift-off lithography conducted with films having about 0.8× the thickness of the LOR 30B layer. LOR 30B can be relatively highly viscous, for example on the order of about 750 cSt, and at low spin speeds can achieve a thickness of about 5 μm. The combined LOR+S1811 photoresist can have a thickness of up to about 6 μm, in which the core thickness can be about 4.0 μm or less.

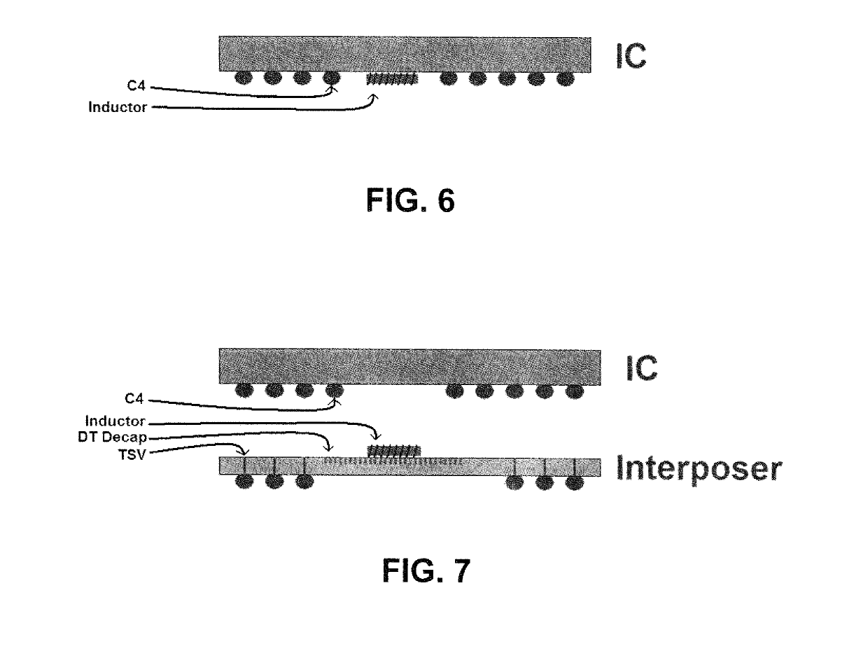

FIG. 6 shows an exemplary embodiment of a power inductor 100 integrated with a complementary metal-oxide semiconductor (CMOS) integrated circuit (IC) according to the disclosed subject matter. The power inductor can be fabricated as described above and deposited directly onto the substrate of the IC, as shown, using any of a variety of suitable deposition techniques, for example by electrodeposition or high-vacuum sputtering. The IC can also include any number of desired components. For example, as embodied, the IC can include one or more capacitor pads (C4) deposited on the IC substrate. An IC according to the disclosed subject matter can be used for DC-DC power conversion. Other applications for an IC including a power inductor 100 according to the disclosed subject matter include a transformer, an electric motor, or any other suitable electronic device.

FIG. 7 shows another exemplary embodiment of a power inductor 100 integrated with a CMOS IC using an interposer, for example for use with a DC-DC power converter. The power inductor 100 can be deposited on an interposer, such as a silicon interposer using any of a variety of suitable deposition techniques, for example by electrodeposition or high-vacuum sputtering. The interposer can include a deep-trench (DT) decoupling capacitor (Decap) proximate to the inductor, for example to isolate noise from the inductor 100 from other circuit components. One or more thru-silicon vias can be formed through the interposer to join to the capacitor pads (C4) of the IC.

### EXAMPLE

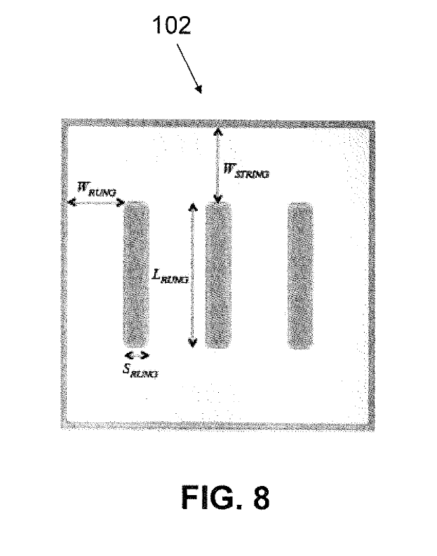

To further demonstrate the benefit of the systems and methods disclosed herein, and merely for purpose of comparison, iterative simulations in an finite element analysis (FEA) simulator, such as Maxwell, can be utilized for numerical parameter selection. For example, FIG. 8 shows a fabricated CZT core 102 with various design dimensions indicated. Exemplary rung width, W_{RUNG}, rung space, S_{RUNG}, rung length, L_{RUNG}, and stringer width, W_{STRING}, of the core, obtained by simulation, were 120 μm, 50 μm, 270 μm and 140 μm respectively, resulting in total device dimensions of 630 μm by 550 μm occupying 0.35 mm². Increasing W_{RUNG} can reduce the reluctance for magnetic flux in the core at the expense of winding length, which can increase DC resistance. S_{RUNG} can be reduced to improve coupling between adjacent inductors, but remain large enough to accommodate the winding vias to be placed between the rungs. Reducing L_{RUNG} can reduce the magnetic path length and increase inductance at the expense of winding cross section, which can increase DC resistance. Increasing W_{STRING} can improve coupling between inductors, where such improvement can have diminishing effect, while the size can consume more total area, and thus can reduce current density.

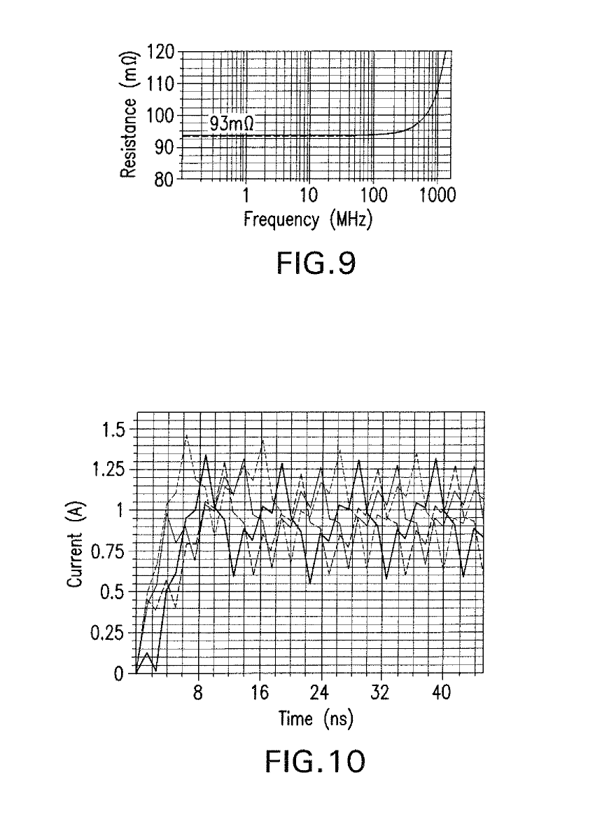

Simulations in Maxwell indicate a peak current density for the device of 11 A/mm², which can be limited by magnetic saturation. The inductor resistance as a function of frequency is shown in FIG. 9, where the DC resistance is 93 m. The relatively thin laminations and relatively high resistivity of CZT can reduce the eddy current losses occurring at frequencies of interest, and thus both inductance and coupling coefficient remain flat as frequency increases. The average L_{self} across the four phases at 100 MHz is 18.4 nH, with a coupling factor of −0.2 between each of the phases. The simulator includes eddy current losses in both the core and the windings along with estimated hysteretic losses, but does not consider relatively more complicated effects, such as domain motion.

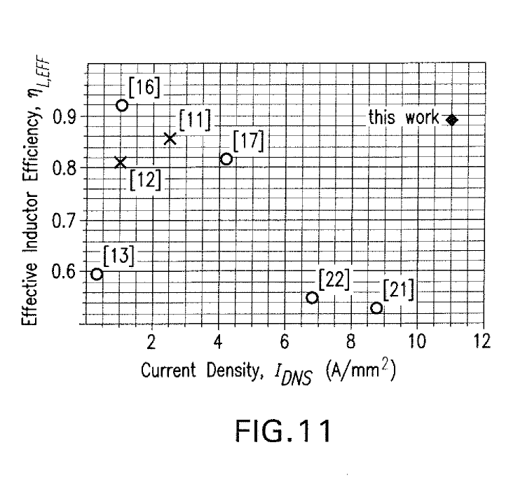

Simulated time-domain waveforms of the inductor current ripple are shown in FIG. 10, where D=0.625. Coupling between the inductor phases can reduce inductor current ripple and maintain the peak flux density below the saturation magnetization (Ms) of CZT, or 1.3 T, as verified by field solutions from the transient simulation. The simulated current density and effective inductor efficiency are shown in FIG. 11 for purpose of comparison against previous works.

For purpose of comparison, in buck converters, the inductor can serve as an energy reservoir, where electrical energy can be periodically stored in a magnetic field and subsequently released to the load at a lower electrical potential. Thus, figures of merit for a candidate power inductor can be inductor quality factor and inductance density.

Maximum energy density, E_{DNS}, can be utilized as an alternative benchmark to inductance density. Where L is self inductance and area is the total area of a single inductor,

$${E}_{DNS} = \frac{{LI}_{SAT}^{2}}{2 \times area} . \qquad ( 1 )$$

Likewise, quality factor can be an indicator of the potential efficiency that can be achieved with a candidate power inductor. The spectral content of the current of the inductor can have strong components at the switching frequency, f_{SW}, as well as at DC and, for the case of coupled inductors, harmonics of f_{SW}.

For purpose of comparison of candidate inductor topologies for integrated voltage regulators (IVRs), complimentary figures of merit, maximum current density, I_{DNS}, and effective inductor efficiency, η_{L,EFF} can be utilized. I_{DNS} can be determined as the maximum average inductor current, I_{L,MAX}, divided by the area of the inductor. The maximum average inductor current, I_{L,MAX} is a function of the inductor saturation current and the worst-case inductor current ripple ΔI_{L,P-P}:

$${I}_{L , MA X} = {I}_{SAT} - \frac{1}{2} Δ {I}_{L , P - P} \qquad ( 2 )$$

For air-core inductors, I_{SAT} can be the peak inductor current, which can be limited by, for example, electromigration or heat. Thus the maximum current density can be

$${I}_{DNS} = \frac{{I}_{L , MA X}}{area} . \qquad ( 3 )$$

Determination of ΔI_{L,P}_{_{—}}_{P} can vary with inductor topology. For example, for uncoupled inductors, ΔI_{L,P}_{_{—}}_{P} can be

$$Δ {I}_{L , P - P} = \frac{{V}_{I N} {T}_{SW} D ( 1 - D )}{L} \qquad ( 4 )$$

where V_{IN} represents the converter input voltage and D represents the converter duty cycle, and can be chosen, for example, to be 0.5 representing a worst-case current ripple.

Inverse coupling between adjacent inductors can be used to increase the maximum current, for example if all inductors are carrying the same DC current. I_{L,MAX} can then be modified to include coupling as

$${I}_{L , MA X} = \frac{{I}_{SAT}}{1 + ( {N}_{C} - 1 ) k} - \frac{1}{2} Δ {I}_{L , P - P} \qquad ( 5 )$$

where N_{C} represents a number of coupled inductors in a coupled set. When N_{C}=2, the relationship between inductor terminal voltages and currents can be

$$[ \begin{matrix}A & B \\ B & A\end{matrix} ] [ \begin{matrix}{V}_{1} \\ {V}_{2}\end{matrix} ] = \frac{\partial }{\partial t} [ \begin{matrix}{i}_{1} \\ {i}_{2}\end{matrix} ] \\ A = \frac{1}{L ( 1 - {k}^{2} )} \\ B = \frac{- k}{L ( 1 - {k}^{2} )} \qquad ( 6 )$$

where L represents the self-inductance of a single phase, k represents the coupling coefficient between two coupled inductors, which can be chosen, for example, to be about −0.8 for N_{C}=2 and v₁, i₁, v₂ and i₂ are, respectively, the voltages across and currents through the two inductors of the coupled pair. A worst-case inductor current ripple for such a configuration can occur when D=0.25 or 0.75, and can be

$$Δ {I}_{L , P - P} = \frac{{V}_{IN} {T}_{SW}}{4 L ( 1 - {k}^{2} )} ( 0.75 + 0.25 k ) \qquad ( 7 )$$

As an example, for a configuration of four inductors, and thus N_{C}=4, each inductor can be coupled to the other three with the same coupling coefficient. The inductor voltage-current relationships can be represented as

$$[ \begin{matrix}A & B & B & B \\ B & A & B & B \\ B & B & A & B \\ B & B & B & A\end{matrix} ] [ \begin{matrix}{v}_{1} \\ {v}_{2} \\ {v}_{3} \\ {v}_{4}\end{matrix} ] = \frac{\partial }{\partial t} [ \begin{matrix}{i}_{1} \\ {i}_{2} \\ {i}_{3} \\ {i}_{4}\end{matrix} ] \\ A = \frac{1 + 2 k}{L ( 1 + 2 k - 3 {k}^{2} )} \\ B = \frac{- k}{L ( 1 + 2 k - 3 {k}^{2} )} . \qquad ( 8 )$$

Further, N_{C} symmetric inversely coupled inductors can have a coupling coefficient up to −1/(N_{C}−1). The worst-case inductor current ripple for N_{C}=4 can occur when D=0.375 or 0.625, and can be represented as

$$Δ {I}_{L , P - P} = \frac{{V}_{IN} {T}_{SW}}{8 L ( 1 + 2 k - 3 {k}^{2} )} ( 1.875 + 5.125 k ) \qquad ( 9 )$$

Similar analysis can be conducted to determine the worst-case inductor current ripple for any N_{C}.

The effective inductor efficiency η_{L,EFF} can be determined as a ratio between power delivered to the load and a power input to the inductors. Loss contributors in inductors can be, for example, DC and high-frequency resistive losses, which can account for winding resistance, core eddy currents, and magnetic hysteresis. Thus, η_{L,EFF} can be represented as

$${η}_{L , EFF} = \frac{{I}_{L , M AX} {V}_{OUT}}{{I}_{L , MA X} {V}_{OUT} + {R}_{D C} {I}_{L , MA X}^{2} + {R}_{fsw} \frac{Δ {I}_{L , P - P}^{2}}{12}} \qquad ( 10 )$$

where R_{DC} represents the DC inductor resistance, R_{fsw} represents the inductor resistance at fSW, and V_{OUT} represents the IVR output voltage. In eq. 10, the rms power of the current waveform can be represented as that of a triangle wave with peak-to-peak current ripple of ΔI_{L,P-P}.

Within these two figures of merit, V_{IN}, T_{SW} and V_{OUT} can remain free variables independent of the power inductors, yet can influence the performance according to I_{DNS} and η_{L,EFF}. Exemplary value for these parameters can be V_{IN}=2V, T_{SW}=100 MHz and V_{OUT}=1V.

Spiral inductors, or other topologies that can be integrated into the back-end-of-line (BEOL) of a complementary metal-oxide semiconductor (CMOS) process, can be too resistive to provide efficient on-chip power conversion at acceptable current densities. Relatively efficient use of surface mount (SMT) air-core inductors can provide a current density of about 1.0 A/mm², for example. However, an IVR incorporating discrete SMT inductors for power conversion with core-level granularity can have limited scalability due to the size and discrete nature of the SMT devices.

Integrated thin-film magnetic core power inductors can have improved scalability and density, which can reduce complications associated with integrated buck converters. Some devices can have a higher inductance density than air-core inductors, but the currents that can be supported can be limited by magnetic saturation. Introducing coupling between magnetic core inductors can mitigates magnetic saturation while allowing improved transient response. For example, a 16-phase buck converter can utilize coupled stripe inductors with sputtered Ni₈₀Fe₂₀ cladding and can deliver about 25 A, with a current density of about 8 A/mm² and an efficiency up to about 76%. Alternatively, devices can utilize coupled race-track inductors with electroplated Ni₄₅Fe₅₅ integrated into an eight-phase IVR, for example by chip stacking, and can achieve a maximum current density of about 1.7 A/mm² and an efficiency up to about 74%, with a current density of about 1 A/mm² where approximately 74% of losses occur in the inductor.

For purpose of comparison, the performance of power inductors described herein and other known inductors is shown in FIG. 11. The maximum current density and effective inductor efficiency of power inductors described herein ♦ and known inductors × and ◯ are shown.

The foregoing merely illustrates the principles of the disclosed subject matter. Various modifications and alterations to the described embodiments will be apparent to those skilled in the art in view of the teachings herein. It will be appreciated that those skilled in the art will be able to devise numerous modifications which, although not explicitly described herein, embody its principles and are thus within its spirit and scope.

1. A magnetically isotropic core comprising two or more laminations,
wherein at least a first lamination of the two or more laminations comprises anisotropic magnetic material having a first orientation of magnetic anisotropy; and
at least a second lamination of the two or more laminations comprises anisotropic magnetic material having a second orientation of magnetic anisotropy, the second orientation being different than the first orientation.

2. The core of claim 1, wherein the core comprises at least three laminations, and wherein at least a third lamination comprises anisotropic magnetic material having a third orientation of magnetic anisotropy, the third orientation being different than each of the first orientation and the second orientation.

3. The core of claim 1, wherein the core comprises successive laminations of anisotropic magnetic material, and wherein each lamination in the successive laminations has a rotated magnetic orientation of anisotropy relative to the orientation of a preceding lamination in the successive laminations.

4. The core of claim 1, wherein the anisotropic magnetic material is selected from an amorphous alloy of Cobalt, Tantalum, and Zirconium, or a polycrystalline or crystalline alloy of Nickel and Iron.

5. The core of claim 1, further comprising an insulating layer between each two successive laminations of the anisotropic magnetic material.

6. The core of claim 5, wherein the insulating layer comprises a layer of SiO2.

7. The core of claim 6, wherein the insulating layer further comprises a layer of Ta.

8. The core of claim 5, wherein the thickness of the insulating layer is within a range between about 5-10 nanometers.

9. An inductor comprising a core of claim 1 and a winding wrapping around the core.

10. The inductor of claim 9, wherein the core has a toroidal configuration.

11. The inductor of claim 9, wherein the core has a ladder topology comprising at least two rungs and a spacing between the at least two rungs, and wherein the winding comprises separate sets of windings each wrapping around one of at least two rungs, respectively.

12. The inductor of claim 11, wherein the core comprises four rungs and four sets of windings each wrapping around one of the four rungs, respectively.

13. A microchip or integrated circuit comprising an inductor of claim 9.

14. The microchip or integrated circuit of claim 13, wherein the microchip or integrated circuit is used for a DC-DC power converter.
